(19) United States
(12) Patent Application Publication
(10) Pub. No.: US 2010/0322506 A1
(43) Pub. Date: Dec. 23, 2010

(54) INSPECTION PARAMETER SETTING METHOD, INSPECTION PROPERTY EVALUATION METHOD AND INSPECTION SYSTEM

(76) Inventors: Yoshinori MURAMATSU, Tokyo (JP); Ryoji Shiwaku, Hadano (JP); Tadashi Iida, Atsugi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/819,514

(22) Filed: Jun. 21, 2010

(30) Foreign Application Priority Data
Jun. 23, 2009 (JP) 2009-149098

(51) Int. Cl. G06K 9/00

(52) U.S. Cl. 382/149

(57) ABSTRACT

An inspection system is disclosed, which inspects a wiring pattern on a high multilayer printed wiring board while determining a calibration position with a smaller number of error reports, and predicts the verification work time by evaluating the inspection property. Based on the CAD data of each layer of the printed wiring board to be inspected and the layer structure information, an intensity composition map viewed through the inspection surface is generated. A plurality of sets of the intensity components of the inspection surface are determined, and after determining at least one intensity evaluation region covering all the sets, the intensity evaluation region is imaged by an inspection unit and the statistical intensity value corresponding to each intensity component is determined and substituted into the intensity composition map. The inspection is conducted by determining the optimal calibration position for determining an inspection threshold value in this way.

### INCORPORATION BY REFERENCE

The present application claims priority from Japanese application JP2009-149098 filed on Jun. 23, 2009, the content of which is hereby incorporated by reference into this application.

### BACKGROUND OF THE INVENTION

This invention relates to an inspection system for inspecting by image processing of a defect of a wiring pattern on a printed wiring board such as a high multilayer printed wiring board having a plurality of layers, or in particular, to an inspection parameter setting method and a method of evaluating the inspection property (degree of difficulty).

Generally, the process of manufacturing a printed wiring board is accompanied by a wiring pattern defect such as an open, a mouse bite, a protrusion or a shorting of the wiring pattern. The conformity or nonconformity of such a defect is determined mainly using an inspection system in accordance with an inspection specification, and the image of any suspected defective portion is displayed as a defect candidate, and the conformance or non-conformance is finally determined by visual check (hereinafter referred to as “the verification work”) by the human being.

In the inspection system, the wiring pattern of a specified portion is picked up as an image by a CCD camera, and the particular image is output to an A/D converter. The A/D converter converts the image into a multiple-tone digital image data, from which an intensity histogram is generated.

Then, an image high in contrast is acquired through a calibration process in which the concentration of each intensity is changed using arbitrary peak intensity values, or mainly, peak values on low- and high-intensity sides obtained as required from the intensity histogram. Based on this image, another intensity histogram is generated and an inspection threshold value determined.

Subsequently, the range of the printed wiring board to be inspected is scanned by the CCD camera, and a contour of an obtained image is extracted to produce a contour data. Further, the CAD data is compared with the contour data, and based on the difference therebetween, a defect candidate is determined and an image thereof is displayed on a monitor.

According to the invention described in JP-A-2000-329532, for example, a wiring pattern is imaged using the dark field illumination, the microscope and the CCD camera, the cross section of the gray levels of the wiring pattern image is obtained and an inspection threshold value is determined. By extracting a contour of the image in accordance with this inspection threshold value, the inspection can be conducted in stable manner regardless of the imaging position.

JP-A-2008-144071, on the other hand, discloses a resin composition of a material making up a printed wiring board to form an image high in contrast.

### SUMMARY OF THE INVENTION

With the recent demand for a higher function and a shorter delivery time of electronic devices, however, the number of layers and the density of the printed wiring board have remarkably increased, and so has the importance of the characteristics such as heat resistance and electric isolation.

The high multilayer printed wiring board produced to meet this demand is formed of various materials, and has a complicated combination of signals and a layer structure such as the thickness of a power source layer conductor and the distance between and the thickness and type of the material of insulating layers. Many printed wiring boards having this layer structure are formed of various intensity components, and in the wiring pattern inspection thereof, it is important to determine the inspection threshold value for distinguishing the intensities of the wiring pattern and the insulating materials from each other.

According to JP-A-2000-329532 in which the inspection threshold value is determined using the CCD camera or the microscope having the dark field illumination, however, various intensity components are difficult to distinguish from each other. Also, the method in which a microscopic region is scanned under microscope consumes a great amount of time for inspection of large boards, and fails to meet the demand for shortening the delivery time.

The use of the resin component having an improved contrast described in JP-A-2008-144071, on the other hand, requires many changes and readjustments of the manufacturing processes, and is limited in application due to the high materials cost.

In both techniques described above, assume that an inspection threshold value is set erroneously to obtain the contour of a wiring pattern. Then, the inspection system might regard the portions such as clearances other than the wiring pattern as a part of the wiring pattern in obtaining the contour of the wiring pattern, resulting in an increased number of defect candidates and a longer time for the verification work.

On the other hand, in view of the fact that the inspection process produces no added value, the lead time of the inspection process is liable to be substantially ignored. In many cases, therefore, a sufficient inspection time is not set in the production plan.

Accordingly, it is an object of this invention to provide an inspection parameter setting method, an inspection property evaluation method and an inspection system in which an optimal calibration position is determined to set an inspection threshold value accompanied by a smaller number of error reports at the time of inspection of a high multilayer printed wiring board having various intensity components, and the inspection property is evaluated in advance to predict the verification work time.

The above and other objects, features and advantages will be made apparent by the detailed description taken in conjunction with the accompanying drawings.

A representative one of the aspects of the invention disclosed herein is briefly explained below.

In the outline of the operation of a representative one of the aspects of the invention, the CAD data is synthesized based on the CAD data of the various layers making up a printed wiring board to be inspected and the information on the layer structure thereof, and thus an intensity composition map as viewed through the inspection surface is prepared. In the case where the conductor of the inspection surface is thick, the intensity composition map is generated by correcting the CAD data based on the etching factor of the inspection surface which is set as required. From this intensity composition map, sets of the intensity components making up the inspection surface are determined, and at least one intensity evaluation region covering all the sets is determined. This intensity evaluation region is imaged by the inspection system, and by thus acquiring and analyzing the intensity data corresponding to each intensity component, each statistical intensity value is determined.

The advantage obtained from the representative one of the aspects of the invention disclosed herein is briefly explained below.

Specifically, the advantage obtained from the representative one of the aspects of the invention is that at the time of inspecting a high multilayer printed wiring board having various intensity components, an optimal calibration position is determined to set an inspection threshold value having a smaller number of error reports and the verification work time is predicted thereby to improve the inspection property on the one hand and optimize the lead time of the inspection process on the other hand.

Other objects, features and advantages of the invention will become apparent from the following description of the embodiments of the invention taken in conjunction with the accompanying drawings.

### BRIEF DESCRIPTION OF THE DRAWINGS

FIG. 1 is a flowchart showing the processing steps for the inspection conducted by an inspection system according to an embodiment of the invention.

FIG. 2 is a flowchart sowing the processing steps for determining the optimal calibration position in the inspection system according to an embodiment of the invention.

FIG. 3 is a flowchart showing the processing steps for determining the error report density in the inspection system according to an embodiment of the invention.

FIG. 4 is a diagram showing the configuration of the inspection system according to an embodiment of the invention.

FIG. 5 is a diagram showing a cross section of the stage portion of the inspection unit of the inspection system according to an embodiment of the invention.

FIG. 6 is a diagram showing a sectional structure of a printed wiring board for explaining the layer structure information used in the inspection system according to an embodiment of the invention.

FIG. 7 is a diagram showing a sectional structure of a printed wiring board for explaining the layer structure information used in the inspection system according to an embodiment of the invention.

FIG. 8 is a diagram showing a sectional structure of a printed wiring board for explaining the layer structure information used in the inspection system according to an embodiment of the invention.

FIG. 9 is a plan view of each layer of the printed wiring board for explaining the CAD data used in the inspection system according to an embodiment of the invention.

FIG. 10 is a plan view of each layer of the printed wiring board for explaining the CAD data used in the inspection system according to an embodiment of the invention.

FIG. 11 is a plan view of each layer of the printed wiring board for explaining the CAD data used in the inspection system according to an embodiment of the invention.

FIG. 12 is a plan view of each layer of the printed wiring board for explaining the CAD data used in the inspection system according to an embodiment of the invention.

FIG. 13 is a plan view of each layer of the printed wiring board for explaining the CAD data used in the inspection system according to an embodiment of the invention.

FIG. 14 is a diagram for explaining an example of correcting the CAD data based on the etching factor of the inspection system according to an embodiment of the invention.

FIG. 15 is a diagram for explaining an example of correcting the CAD data based on the etching factor of the inspection system according to an embodiment of the invention.

FIG. 16 is a diagram showing a 3×3 scanner of the inspection system according to an embodiment of the invention.

FIG. 17 is a diagram for explaining an example of determining an intensity evaluation region of the inspection system according to an embodiment of the invention.

FIG. 18 is a diagram for explaining an example of determining an intensity evaluation region of the inspection system according to an embodiment of the invention.

FIG. 19 is a diagram for explaining an example of determining the optimal calibration region of the inspection system according to an embodiment of the invention.

FIG. 20 is a diagram for explaining an example of predicting the verification work time in the inspection system according to an embodiment of the invention.

FIG. 21 is a diagram for explaining an example of predicting the verification work time in the inspection system according to an embodiment of the invention.

### DESCRIPTION OF THE EMBODIMENTS

Embodiments of the invention are explained in detail below with reference to the drawings. Incidentally, in all the diagrams used for explaining the embodiments, the same component members are basically designated by the same reference numerals, respectively, and not explained repeatedly.

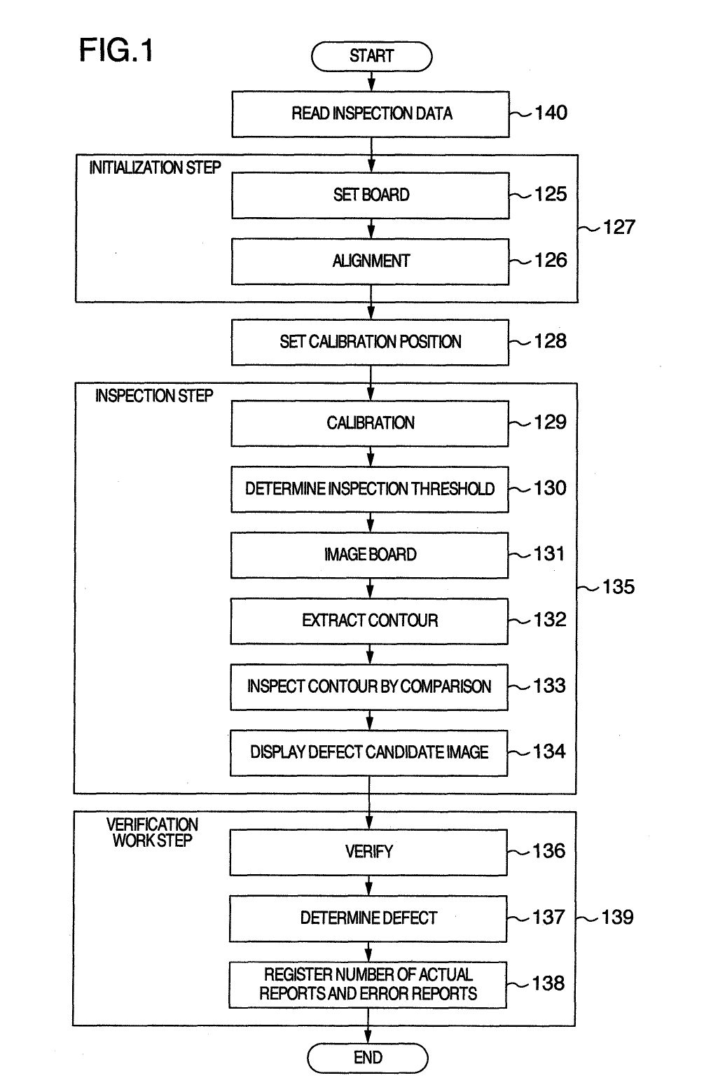

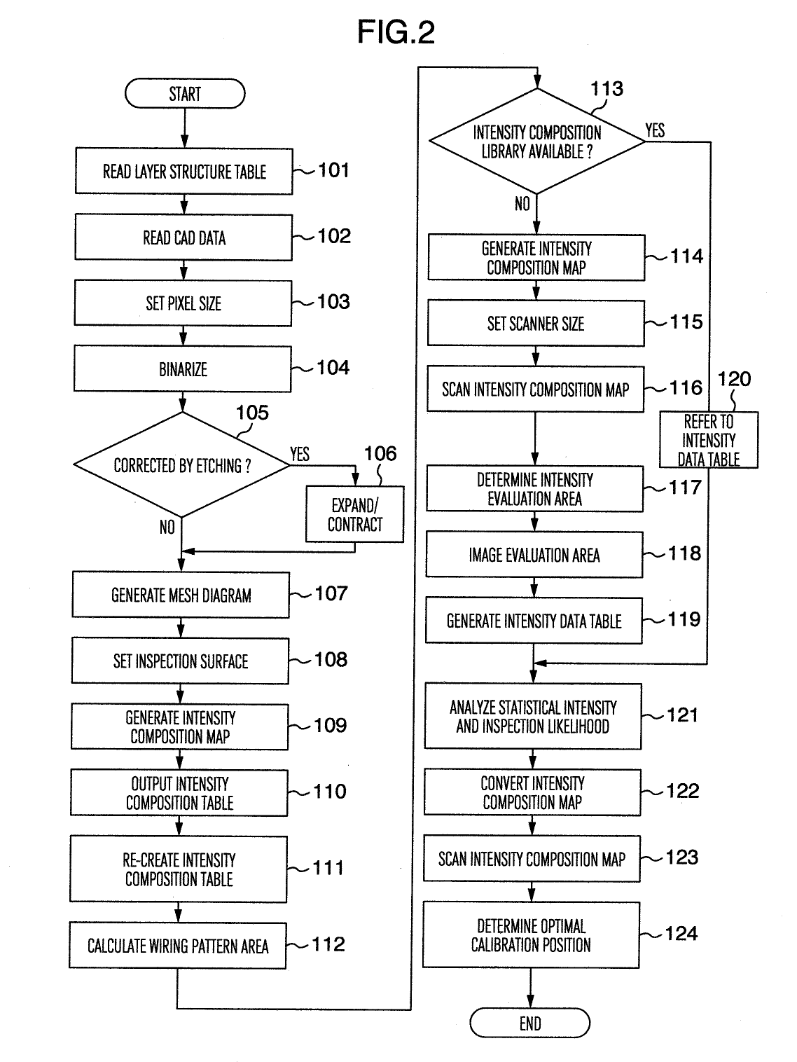

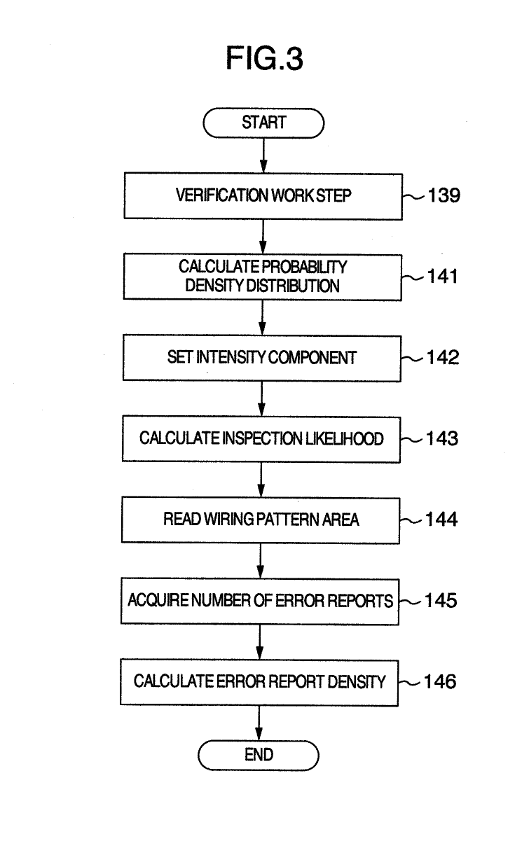

The processing steps for the inspection system according to an embodiment of the invention are explained below with reference to FIGS. 1 to 3. FIG. 1 is a flowchart showing the processing steps for the inspection system according to an embodiment of the invention, FIG. 2 a flowchart showing the processing steps to determine the optimal calibration position for the inspection system according to an embodiment of the invention, and FIG. 3 a flowchart showing the processing steps for determining the error report density of the inspection system according to an embodiment of the invention.

First, in the processing steps for inspection of the inspection system, as shown in FIG. 1, the inspection data of a printed wiring board to be inspected are read into an inspection unit (step 140). The inspection data include the CAD data on the contour of the printed wiring board to be inspected and the inspection specification. The inspection data further include the position information for board alignment and the position information on a specified portion for calibration of an image picked up.

The printed wiring board to be inspected is set in the inspection unit (step 125). Based on the alignment position information obtained from the inspection information, images of a plurality of points on the inspection board are picked up, and by forming a contour of the image data thus obtained, the alignment process is executed to set the corresponding CAD data in position (step 126).

The process including the setting of the board (step 125) to the alignment (step 126) is called an initialization step (step 127).

Then, in order to determine an inspection threshold value, a specified calibration position registered in the inspection data is set in the inspection unit (step 128). In many cases, this calibration position is set in design stage at the densest portion of the wiring pattern in the CAD data of the printed wiring board to be inspected.

The image of the wiring pattern of the specified portion is picked up by the CCD camera and output to the A/D converter. In the A/D converter, the image is converted into a multiple-tone digital image data, and an intensity histogram is generated from this image data. Based on the intensity histogram, the calibration is made (step 129) to change the concentration of each intensity using an arbitrary peak intensity value as required or, mainly, a peak value on low intensity side and a peak value on high intensity side, thereby producing an image high in contrast.

From this image, an intensity histogram is generated, and an inspection threshold value convenient for wiring pattern inspection is determined (step 130). After that, the inspection range of the printed wiring board is scanned by the CCD camera, and by thus picking up an image of the board, an image of the wiring pattern is acquired (step 131).

In accordance with the inspection threshold value determined in step 130, a contour of the image is generated thereby to produce a contour data (step 132). Further, a contour comparison test is conducted in which the CAD data is compared with the contour data and a defect candidate is determined from the difference (step 133). The image of the defect candidate thus obtained is displayed on the monitor (step 134).

The process from the calibration (step 129) to the defect candidate image display (step 134) is called the inspection step (135).

The verification work is conducted by human visual check of the defect candidate image displayed on the monitor (step 136) thereby to determine the conformity or nonconformity of the defect candidate (step 137). In accordance with the defect type, a marking seal or the like is attached to a defect portion determined as correctable, so that the wiring pattern is often corrected in the subsequent manufacturing process.

Finally, the actual number of reports and the number of error reports providing the statistical information on the inspection result are registered (step 138), thereby ending the inspection. The process from the verification (step 136) to the registration of the registration of the number of actual reports and error reports (step 138) is called the verification work step (step 139).

Also, in the processing steps for determining the optimal calibration position for complementing the calibration position setting (step 128) after the initialization step (step 127) shown in FIG. 1, the inspection system first reads a layer structure table of the printed wiring board to be inspected as shown in FIG. 2 (step 101).

Then, the CAD data for each layer defined in the layer structure table is read (step 102), and in accordance with the CAD data thus read and the resolution of the CCD camera, the pixel size for dividing the CAD data is set (step 103). The CAD data is divided with the set pixel size, and binarized based on the tone information for each pixel of the CAD data thus divided.

In the CAD data used in this embodiment, the wiring pattern is expressed in black with 0 in the number of tone, and the non-wiring region in white with 255 in the number of tones. The data is thus binarized, for example, between tone numbers 0 and 255 for black (0) and white (1), respectively. In the case where the cross section of the wiring pattern is trapezoidal in the wet etching process to form the wire before the inspection process, a difference of the pattern size occurs in the pattern CAD data of the wiring surface. Therefore, the requirement of the etching correction is designated (step 105).

Upon determination in step 105 that the etching correction is required, the CAD data is expanded/contracted (step 106) to present the trapezoidal shape of the wiring pattern. Thus, in the case where the wet etching process is excessively executed, the CAD data is contracted, while in the case where the wet etching is insufficient, on the other hand, the wiring pattern becomes thicker than the CAD data and therefore, the expansion process is executed.

Then, a mesh diagram in the designated pixel size is prepared from the binarized CAD data (step 107). After that, the inspection surface of the printed wiring board to be inspected is set (step 108), and an intensity composition map as viewed through the inspection surface is generated in accordance with the set inspection surface (step 109).

Also, the intensity composition table is output using the layer structure information and the intensity component number set in the intensity composition map (step 110). Further, the intensity value of each pixel imaged by the CCD camera is estimated, and the intensity composition table output in step 110 is re-created (step 111). From the intensity composition table thus re-created, the wiring pattern area (size) is calculated (step 112).

Based on the intensity component number defined in the intensity composition table in step 111, the library is checked for registration of the information (step 113). In the case where the information is found yet to be registered in the library in step 113, the intensity composition map is generated in accordance with the intensity composition table prepared in step 111 (step 114).

Then, the scanner size for scanning the intensity composition map is set (step 115). The scanner size desirably satisfies the maximum element size of the CCD camera. Based on the scanner size, the intensity composition map generated in step 114 is scanned (step 116) thereby to determine the intensity evaluation region (step 117).

The intensity evaluation region is imaged actually by the CCD camera (step 118) thereby to prepare an intensity data table (step 119). In the case where the intensity component number is already registered in the library, the process of the intensity composition map generation (step 114) to the intensity data table generation (step 119) is not required, and the value registered in the library is used by accessing the intensity data table (step 120).

From the intensity data table, the statistical intensity is analyzed and so is the inspection likelihood (step 121). Based on the statistical intensity obtained by the analysis, the intensity composition map generated in step 114 is converted (step 122), and by scanning this intensity composition map (step 123), the optimal calibration position is determined (step 124).

In the processing steps for determining the error report density, as shown in FIG. 3, the probability density distribution is calculated after the verification work step (step 139) shown in FIG. 1 (step 141).

As to the intensity components, two types of intensity component numbers are set (step 142) and the inspection likelihood is calculated (step 143). The area of the wiring pattern determined in step 112 shown in FIG. 2 is read (step 144), and the number of error reports registered in step 138 of FIG. 1 is acquired (step 145).

From the area of the wiring pattern and the number of error reports, the error report density is calculated (step 146). The inspection likelihood and the error report density are registered in the library.

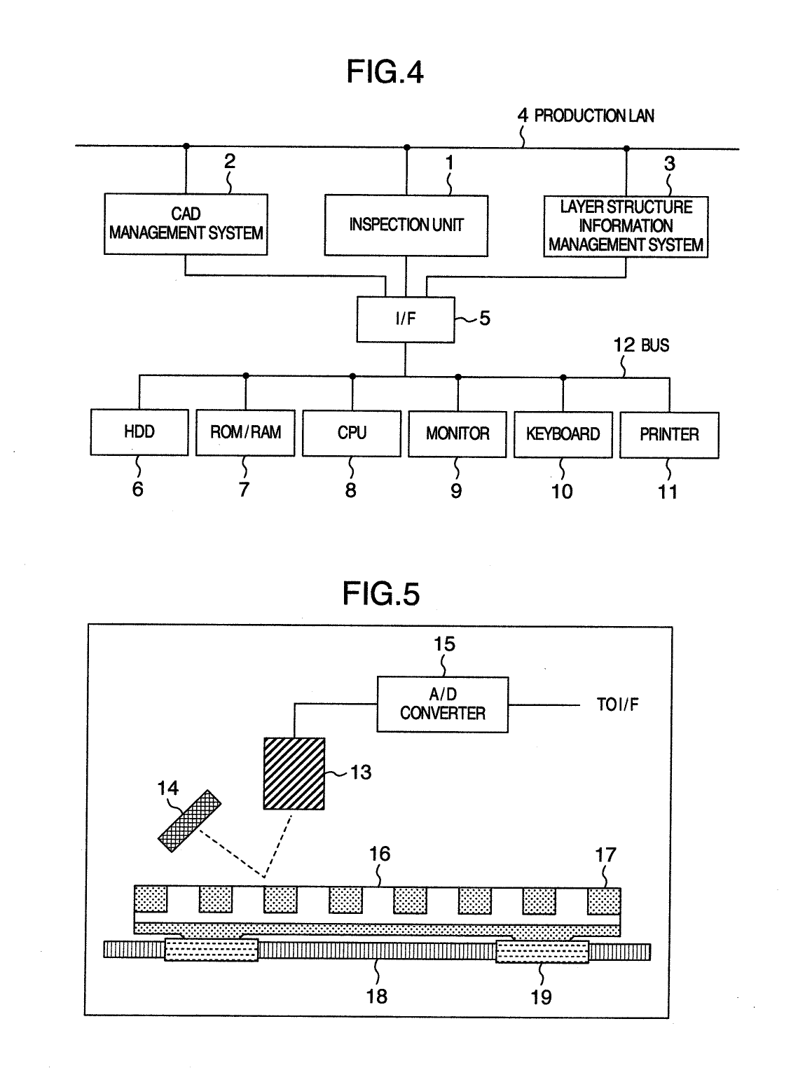

Next, with reference to FIGS. 4 and 5, the configuration of the inspection system according to an embodiment of the invention is explained. FIG. 4 is a diagram showing the configuration of the inspection system according to an embodiment of the invention. FIG. 5 is a sectional view of the stage portion of the inspection system according to an embodiment of the invention.

In FIG. 4, the inspection system is configured of an inspection unit 1 for inspecting an object to be inspected, a CAD management system 2 for managing the CAD data, a layer structure information management system 3 for managing the layer structure information, a hard disk drive (HDD) 6 constituting a storage unit, a memory (ROM/RAM) 7, a CPU 8 constituting an arithmetic unit, a monitor 9, a keyboard 10, a printer 11 and an interface (I/F) 5. The hard disk device (HDD) 6, the memory (ROM/RAM) 7, the CPU 8, the monitor 9 constituting a display unit, the keyboard 10 and the printer 11 are interconnected through a bus 12. The inspection unit 1, the CAD management system 2 and the layer structure information management system 3 are connected through the interface (I/F) 5 to the hard disk drive (HDD) 6, the memory (ROM/RAM) 7, the CPU 8, the monitor 9, the keyboard 10 and the printer 11.

Further, the inspection unit 1, the CAD management system 2 and the layer structure information management system 3 are connected to a production LAN 4.

The data imaged in the inspection unit 1 and the data acquired from the CAD data management system 2 and the layer structure information management system 3 are accumulated in the hard disk drive (HDD) 6 constituting a storage unit through the interface (I/F).

The data accumulated in the hard disk drive (HDD) 6 is appropriately stored in the memory (ROM/RAM) 7 by the CPU 8 providing an arithmetic unit, and calculated according to a program executed by the CPU 8. The result of the calculation is stored in the hard disk drive (HDD) 6 and the memory (ROM/RAM) 7.

Further, the result of the arithmetic operation is output to a display unit such as the monitor 9 or the printer 11 as required. The program begins to be executed by the CPU 8 by the start command input from the keyboard 10 by the operator or the automatic starting function for the program.

The data are transferred between the parts through the bus 12. Further, these data and the information on the result of the arithmetic operation are accessible through the inspection unit 1 by other inspection units and production units connected to the production LAN 4.

This configuration of the inspection system according to this embodiment can be accomplished also using the existing system. With this system configuration, the optimal calibration point can be set to determine the inspection threshold value with few error reports at the time of inspecting the high multilayer printed wiring board having various intensity components on the one hand, and the verification work time can be predicted by evaluating the inspection property in advance on the other hand.

Further, the stage 17 of the inspection unit 1 has such a sectional structure that, as shown in FIG. 5, a plurality of adsorption holes 16 are formed on the stage 17 to adsorb the board. The stage 17 is adapted to move in X and Y directions along a guide 18 by a linear head (driving linear motor) 19.

With the movement of the stage 17, the wiring pattern of the board adsorbed on the stage 17 is imaged by the CCD camera 13 having an illuminator 14. The data thus imaged, after being output to the A/D converter 15 and converted into a multiple-tone digital image data, is accumulated in the hard disk drive (HDD) 6 through the interface (UF) 5.

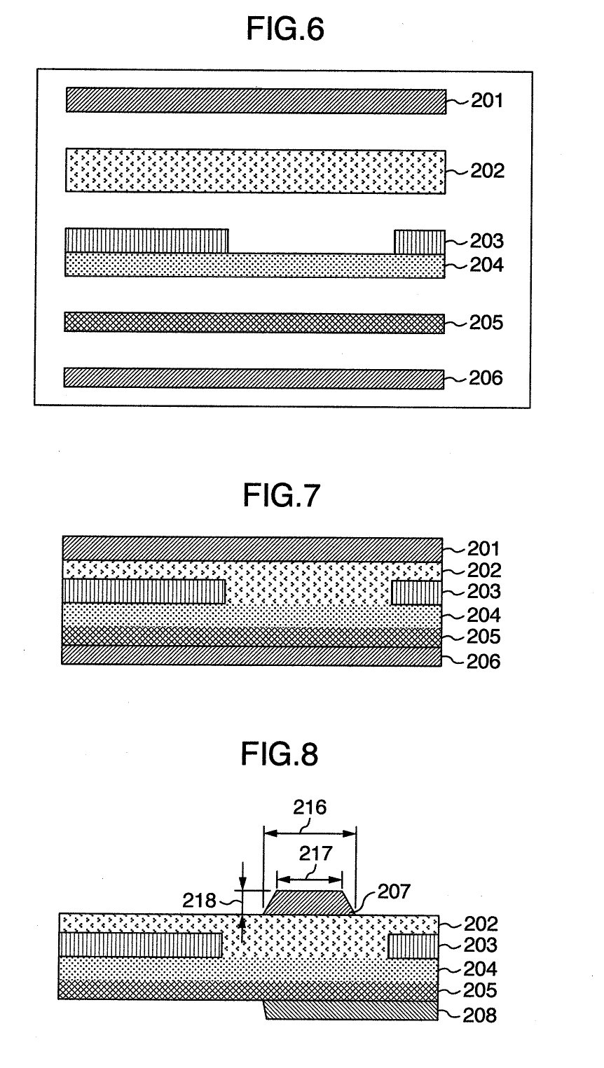

Next, with reference to FIGS. 6 to 8, the layer structure information used for the inspection system according to an embodiment of the invention is explained. FIGS. 6 to 8 are diagrams showing the sectional structure of the printed wiring board for explaining the layer structure information used in the inspection system according to an embodiment of the invention.

FIG. 6 is a diagram showing the layer structure of a three-layer printed wiring board based on Table 1 shown below. The layers are designated as a L1 layer, a L2 layer and a L3 layer, which are configured of a signal layer formed of a L1-layer conductive material 201, a power source layer formed of a L2-layer wiring pattern 203 and a L2-layer insulating material 204, and a signal layer formed of a L3-layer conductive material 206. A L1-L2 layer insulating material 202 is arranged between the L1 and L2 layers, and so is a L2-L3 layer insulating material 205 between the L2 and L3 layers.

The printed wiring board built with this layer structure is heated under pressure in the subsequent lamination press step and thus stacked into a three-layer printed wiring board shown in FIG. 7. Further, through the production processes including the surface grinding step and the wire-forming step, a L1-layer wiring pattern 207 and a L3-layer wiring pattern 208 shown in FIG. 8 are formed.

In many cases, the cross section of these wiring patterns is formed into a trapezoid by wet etching in the wire-forming process. In such a case, the difference between the width 216 of the L1-layer wiring pattern and the width 217 of the L1-layer wiring surface pattern is determined, and the reciprocal of one half of the difference is multiplied by the thickness 218 of the L1-layer wiring conductor to produce an etching factor which is used to express the trapezoid.

TABLE 1

| | | Conductive | Insulating |
|---|---|---|---|
| Layer | Type | material type | material type |
| L1 layer | Signal layer | 201 | 202 |
| L2 layer | Power source layer | 203 | 204 |
| L3 layer | Signal layer | 206 | 205 |

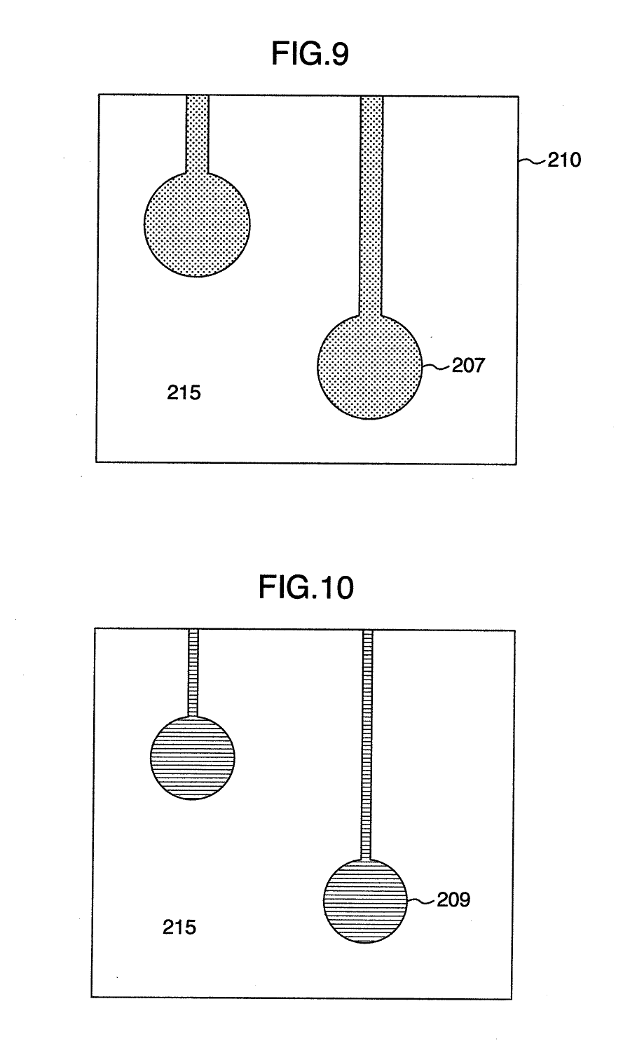

Next, the CAD data used in the inspection system according to an embodiment of the invention is explained with reference to FIGS. 9 to 13. FIGS. 9 to 13 are plan views of the respective layers of the printed wiring board for explaining the CAD data used in the inspection system according to an embodiment of the invention.

FIG. 9 is a diagram showing the L1-layer CAD data of the three-layer printed wiring board shown in FIG. 8, and configured of a L1-layer CAD diagram 210 including a L1-layer wiring pattern 207 and a non-wiring region 215.

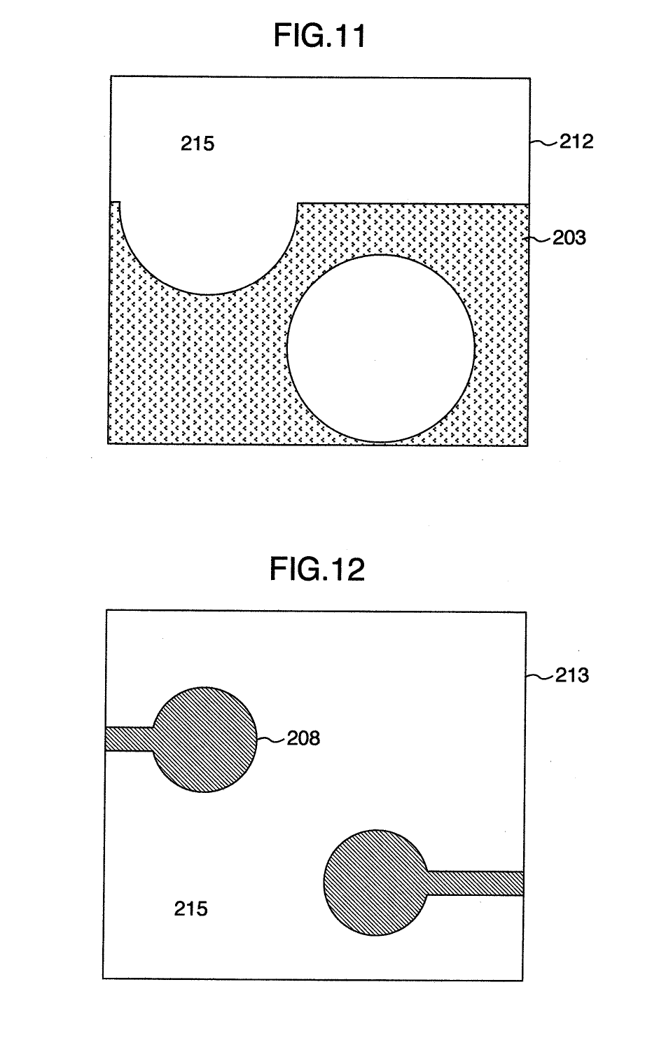

FIG. 11, on the other hand, is a diagram showing the L2-layer CAD data of the three-layer printed wiring board shown in FIG. 8, and configured of a L2-layer CAD diagram 212 including a L2-layer wiring pattern 203 and a non-wiring area 215.

Also, FIG. 12 is a diagram showing the L3-layer CAD data of the three-layer printed wiring board shown in FIG. 8, and configured of a L3-layer CAD diagram 213 including a L3-layer wiring pattern 208 and a non-wiring region 215.

Further, FIG. 10 is a L1-layer CAD diagram corresponding to FIG. 9, in which the L1-layer CAD data is contracted by image processing and the etching factor is taken into consideration. This L1-layer CAD diagram is configured of a L1-layer wiring surface pattern 209 taking the etching factor into consideration and a non-wiring region 215.

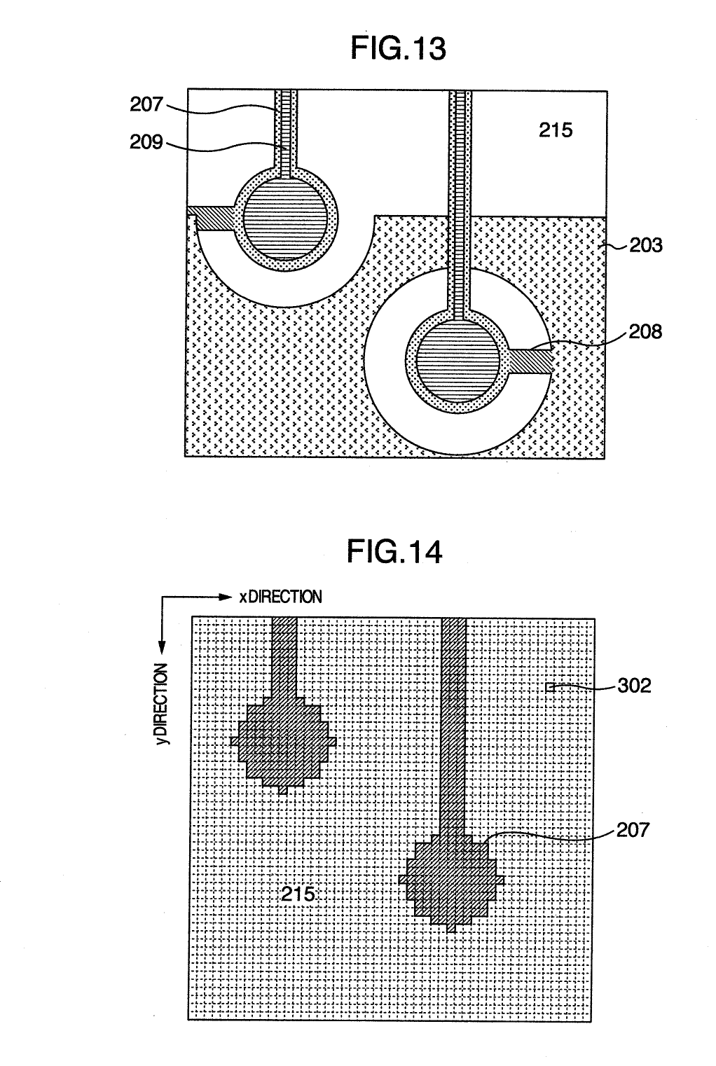

FIG. 13 shows a CAD diagram of any one of the L1 to L3 layers viewed through the L1 layer in FIGS. 9 to 12, and in the embodiment under consideration, the L1 layer is used as an inspection layer.

Next, a specific example of the process executed by the inspection system according to an embodiment of the invention is explained with reference to FIGS. 14 to 21.

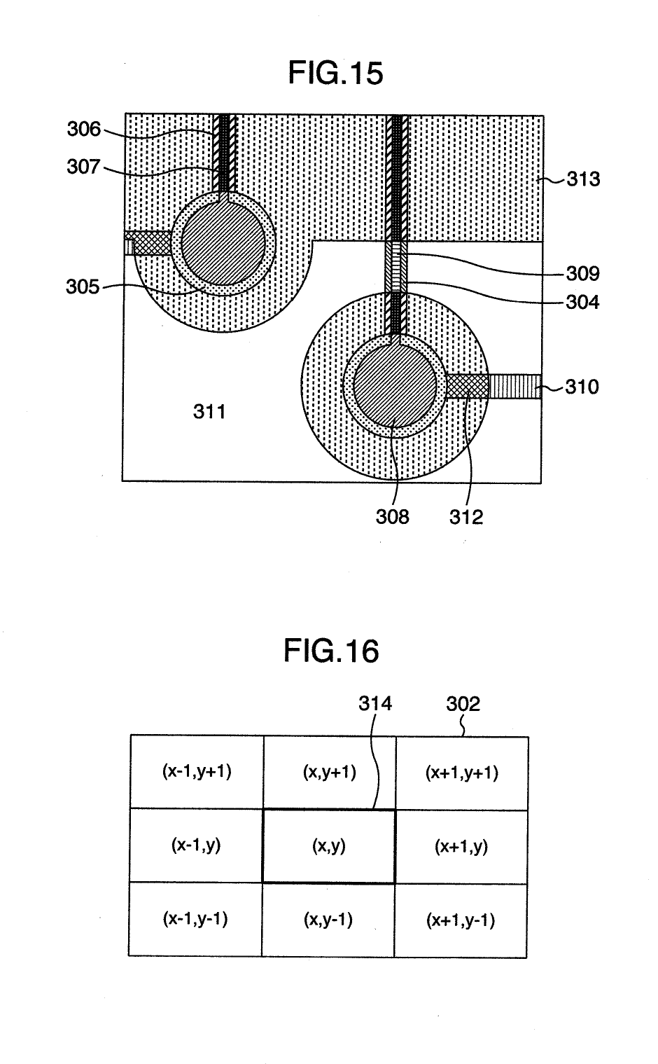

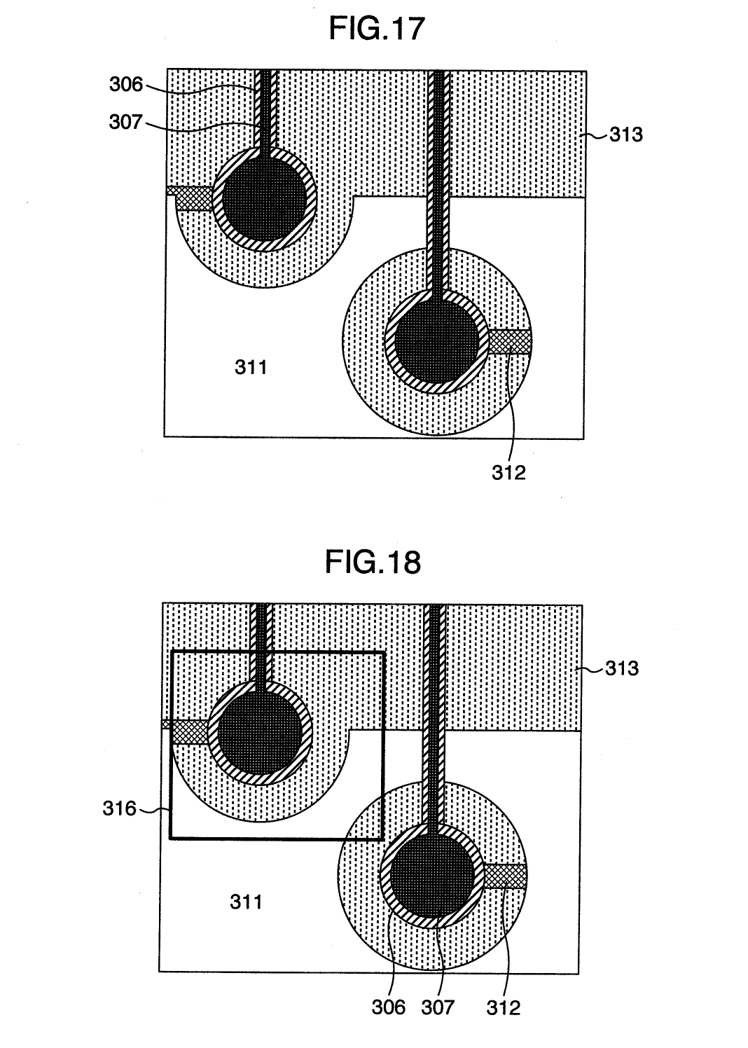

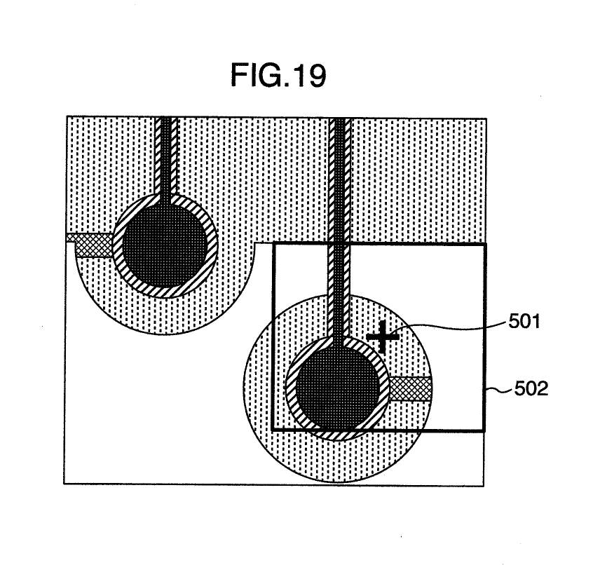

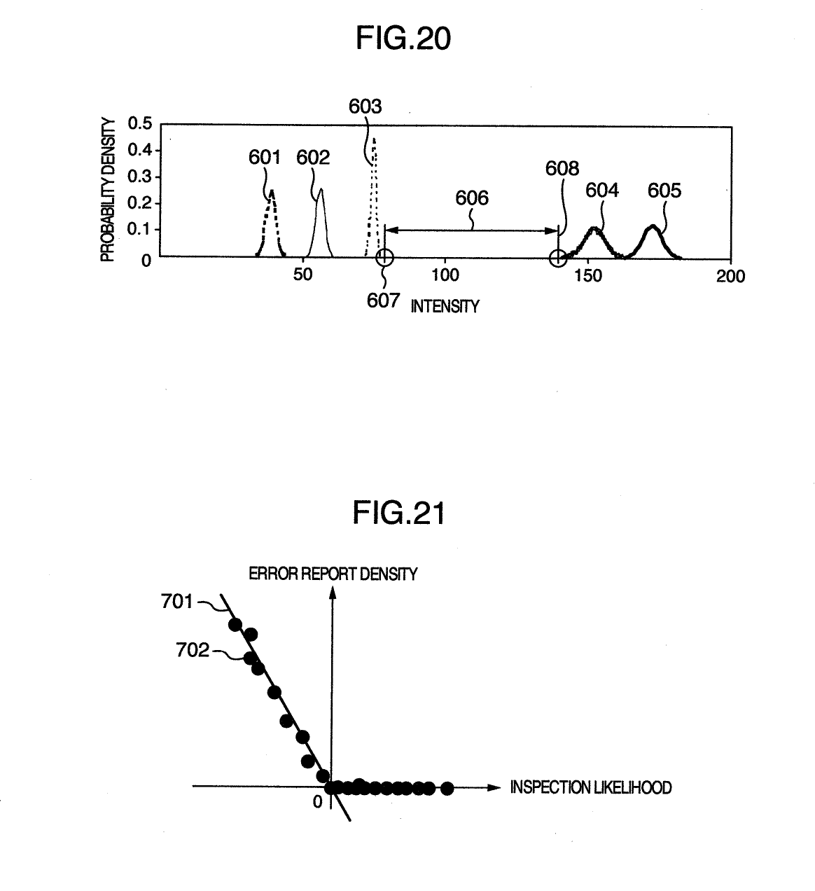

FIGS. 14 to 21 are diagrams for explaining a specific example of the process executed by the inspection system according to an embodiment of the invention, in which FIGS. 14 and 15 are diagrams for explaining an example of correcting the CAD data based on the etching factor, FIG. 16 a diagram showing a 3×3 scanner, FIGS. 17 and 18 diagrams for explaining an example of determining the intensity evaluation region, FIG. 19 a diagram for explaining an example of determining the optimal calibration region, and FIGS. 20 and 21 diagrams for explaining an example of predicting the verification work time.

First, refer to the mesh diagram of FIG. 14 showing the L1-layer CAD data, in which the X-direction board size and the Y-direction board size are divided by designates pixels 302. In this case, the L1-layer wiring pattern 207 is indicated in black with each pixel having 0 in tone number, and the non-wiring area 215 is indicated in white with each pixel having 255 in tone number.

FIG. 16 shows a 3×3 scanner. The diagram of FIG. 14 is scanned from upper left to lower right by this scanner. In the process, the tone values of eight pixels around a target pixel 314 are evaluated, and in the case where at least one of them has the same tone number 255 as the non-wiring region 215, the particular pixel 314 is converted to the tone number of the wiring region 215, thereby completing the L1-layer CAD diagram taking the etching factor shown in FIG. 10 into consideration.

The size of the scanner and the pixel are required to be determined arbitrarily in accordance with the object of evaluation to acquire accurate information. Also, the expansion/contraction process may be executed a plurality of times to achieve a predetermined etching correction amount.

FIG. 15 is a diagram in which, like FIG. 14, FIGS. 11 and 12 are expressed as a mesh, and each diagram expressed in mesh is scanned by the 3×3 scanner shown in FIG. 16. In this way, the state of the lower layer (wiring pattern, insulating material) at each pixel position viewed through the L1 layer is classified, and labeled based on Table 2 showing the intensity composition.

The diagram of FIG. 15 is configured of an intensity component 304 including a L1-layer wiring pattern, a L2-layer wiring pattern and a L3-layer insulating material, an intensity component 305 including a L1-layer wiring pattern, a L2-layer insulating material and a L3-layer wiring pattern, an intensity component 306 including a L1-layer wiring pattern, a L2-layer insulating material and a L3-layer insulating material, an intensity component 307 including a L1-layer wiring surface pattern, a L2-layer insulating material and a L3-layer insulating material, an intensity component 308 including a L1-layer wiring surface pattern, a L2-layer insulating material and a L3-layer wiring pattern, an intensity component 309 including a L1-layer wiring surface pattern, a L2-layer wiring pattern and a L3-layer insulating material, an intensity component 310 including a L1-layer insulating material, a L2-layer wiring pattern and a L3-layer wiring pattern, an intensity component 311 including a L1-layer insulating material, a L2-layer wiring pattern and a L3-layer insulating material, an intensity component 312 including a L1-layer insulating material, a L2-layer insulating material and a L3-layer wiring pattern, and an intensity component 313 including a L1-layer insulating material, a L2-layer insulating material and a L3-layer insulating material.

TABLE 2

| Intensity component number | L1 layer | L2 layer | L3 layer |
|---|---|---|---|
| 304 | Wiring pattern | Wiring pattern | Insulating material |
| 305 | Wiring pattern | Insulating material | Wiring pattern |
| 306 | Wiring pattern | Insulating material | Insulating material |
| 307 | Wiring surface pattern | Insulating material | Insulating material |
| 308 | Wiring surface pattern | Insulating material | Wiring pattern |
| 309 | Wiring surface pattern | Wiring pattern | Insulating material |
| 310 | Insulating material | Wiring pattern | Wiring pattern |
| 311 | Insulating material | Wiring pattern | Insulating material |
| 312 | Insulating material | Insulating material | Wiring pattern |
| 313 | Insulating material | Insulating material | Insulating material |

Next, based on FIG. 15 and Table 2, the intensity value of each pixel imaged by the CCD camera 13 in actual inspection is estimated, and an intensity composition map after recombination shown in FIG. 17 is generated.

At the pixel position indicated by the wiring pattern or the wiring surface pattern of the L1 layer in FIG. 15 and Table 2, the light emitted from an illuminator 14 at the time of inspection is reflected on the L1 layer and not affected by the lower layers including the L2 and L3 layers. Table 2, therefore, can be reclassified into an intensity composition table after recombination shown in Table 3 below.

Finally, the intensity composition map after recombination thus generated and shown in FIG. 17 constitutes the one generated by viewing through the inspection surface according to this embodiment.

In this case, the inspection is concentrated on the five types of intensity components including the intensity component 306 having the L1-layer wiring pattern, the L2-layer insulating material and the L3-layer insulating material, the intensity component 307 having the L1-layer wiring surface pattern, the L2-layer insulating material and the L3-layer insulating material, the intensity component 311 having the L1-layer insulating material, the L2-layer wiring pattern and the L3-layer insulating material, the intensity component 312 having the L1-layer insulating material, the L2-layer insulating material and the L3-layer wiring pattern, and the intensity component 313 having the L1-layer insulating material, the L2-layer insulating material and the L3-layer insulating material.

TABLE 3

| Intensity component number | L1 layer | L2 layer | L3 layer |
|---|---|---|---|
| 306 | Wiring pattern | Insulating material | Insulating material |
| 307 | Wiring surface pattern | Insulating material | Insulating material |
| 311 | Insulating material | Wiring pattern | Insulating material |
| 312 | Insulating material | Insulating material | Wiring pattern |
| 313 | Insulating material | Insulating material | Insulating material |

Also, as shown in FIG. 18, the intensity composition map after recombination shown in FIG. 17 which is concentrated on five types of intensity components is scanned as an image from upper left to lower right with the 3×3 scanner of FIG. 16 in the size of 50×50.

This scanner size desirably satisfies the maximum element size of the CCD camera 13. At the time of scanning all the pixels from upper left to lower right of the image with this scanner, the number of the intensity components (area of each intensity component) and the type of the intensity components included in the scanner for each target pixel are counted.

After complete scanning of all the pixels, the area and the type of each intensity component are evaluated for each target pixel, and the intensity evaluation region 316 is determined as a core of the intensity evaluation regions at X and Y coordinates of the target pixel having the greatest number of intensity component types with a small variation in the area of the intensity component.

In the case where the intensity evaluation region including the five types of intensity components described in Table 3 cannot be determined according to this method, however, the intensity evaluation region having the second largest number of intensity component types including the type of the remaining intensity component is evaluated.

Also, the intensity components in each intensity evaluation region may be duplicated. In this way, at least one intensity evaluation region including all the intensity component types is determined. Next, the board to be inspected is set on the inspection unit and the intensity evaluation region determined is imaged. Then, an intensity data table for each intensity component is generated as Table 4 shown below.

TABLE 4

| | Intensity component No. | | | | |
|---|---|---|---|---|---|
| Pixel No. | 306 | 307 | 311 | 312 | 313 |
| 1 | 153 | 172 | 57 | 40 | 75 |
| 2 | 149 | 173 | 56 | 39 | 76 |
| 3 | 152 | 171 | 57 | 40 | 75 |
| 4 | 150 | 171 | 57 | 39 | 75 |
| 5 | 150 | 171 | 56 | 39 | 75 |
| 6 | 151 | 170 | 55 | 39 | 76 |
| 7 | 148 | 169 | 56 | 38 | 76 |
| 8 | 147 | 173 | 55 | 35 | 76 |
| 9 | 152 | 175 | 56 | 39 | 77 |
| 10 | 153 | 176 | 54 | 38 | 77 |
| 11 | 151 | 172 | 55 | 39 | 76 |
| 12 | 152 | 172 | 55 | 39 | 76 |
| 13 | 152 | 178 | 56 | 39 | 76 |
| 14 | 155 | 180 | 56 | 39 | 75 |
| 15 | 153 | 176 | 57 | 39 | 76 |
| 16 | 150 | 176 | 57 | 40 | 76 |
| 17 | 149 | 181 | 58 | 41 | 75 |
| 18 | 151 | 176 | 57 | 39 | 75 |
| 19 | 147 | 171 | 56 | 35 | 74 |
| 20 | 149 | 174 | 57 | 40 | 73 |
| 21 | 149 | 174 | 55 | 39 | 74 |
| 22 | 152 | 170 | 54 | 38 | 72 |
| 23 | 150 | 172 | 55 | 39 | 73 |
| 24 | 156 | 173 | 54 | 38 | 74 |
| 25 | 155 | 172 | 54 | 38 | 74 |
| 26 | 155 | 176 | 54 | 37 | 75 |
| 27 | 150 | 173 | 55 | 39 | 75 |
| 28 | 153 | 172 | 55 | 39 | 75 |
| 29 | 151 | 169 | 55 | 37 | 75 |
| 30 | 153 | 174 | 56 | 35 | 74 |

The average of the mass of the intensity data corresponding to each intensity component number and the standard deviation are calculated thereby to calculate the statistical intensity value for each intensity component shown in Table 5 below.

TABLE 5

| Intensity component No. | Average | Standard deviation |
|---|---|---|
| 306 | 152 | 3.64 |
| 307 | 172 | 3.29 |
| 311 | 56 | 1.53 |
| 312 | 39 | 1.60 |
| 313 | 74 | 0.89 |

The average of this statistical intensity value is substituted into each intensity component number in the intensity composition map after recombination shown in FIG. 17, and all the pixels from upper left to lower right of the image are scanned again using the scanner shown in FIG. 16. Also in this case, like in FIG. 18, the scanner size is set to 50×50.

The scanner size is desirably in keeping with the maximum element size of the CCD camera 13. In the scanning operation of this scanner, the range determined from the number of each intensity component (area of each intensity component) included in the scanner for each target pixel, the type, the standard deviation and the maximum and minimum values of the intensity components is counted. After scanning all the pixels, one target pixel having the largest standard deviation and range and the greatest number of types of intensity components is determined as an optimal calibration position.

FIG. 19 shows the optimal calibration position. A calibration region 502 is determined at the center of the optimal calibration position 501. Incidentally, the calibration region 502 has the scanner size.

Each intensity component and the area thereof according to this embodiment is shown in Table 6 below. In determining the optimal calibration position shown in FIG. 19, the number of the intensity components counted using the scanner shown in FIG. 16 is output in units of pixel as the area of the intensity component, and the area of the wiring pattern of the L1 layer of the inspection surface, i.e. the sum of the intensity component numbers 306 and 307 is determined as the area of the wiring pattern according to this embodiment.

TABLE 6

| Intensity component No. | Intensity component area | Wiring pattern area |
|---|---|---|
| 306 | 1932 | 5104 |
| 307 | 3172 | |
| 311 | 18640 | |
| 312 | 464 | |
| 313 | 15792 | |

FIG. 20 shows the probability density distribution and the inspection likelihood of each intensity component. In the case where the intensity is plotted along the abscissa and the probability density along the ordinate, reference numerals 601, 602, 603, 604, 605 designate the probability density distribution corresponding to the intensity component numbers 312, 311, 313, 306, 307, respectively, and this distribution is expressed in the shape of normal distribution defined by the equation of Expression 1 below.

$$y = \frac{1}{\sqrt{2 π {σ}^{2}}} {e}^{- \frac{{( x - ave )}^{2}}{2 {σ}^{2}}} \qquad [ Expression 1 ]$$

In FIG. 20, reference numeral 607 designates the position of the foot on positive side of the probability density distribution 603, i.e. the position of the average +3σ of the intensity component number 313.

Reference numeral 608 designates the position of the foot on negative side of the probability density distribution 604, i.e. the position of the average value −3σ of the intensity component number 306. The magnitude of the difference between the intensity positions designated by numerals 608 and 607 is indicated by numeral 606 as an inspection likelihood.

FIG. 21 is a diagram showing the inspection likelihood and the error report density registered in the library, in which the inspection likelihood is plotted along the abscissa and the error report density along the ordinate. In FIG. 21, numeral 701 designates the first-order approximation formula indicating the relation between the inspection likelihood less than 0 and the error report density, and numeral 702 each plot. In each plot, assuming that the abscissa representing the inspection likelihood is expressed as (x1, x2, . . . ) and the ordinate representing the error report density as (y1, y2, . . . ), the first-order approximation formula is given by Expression 2 below.

The inspection likelihood and the wiring pattern area of the printed wiring board to be inspected are actually determined by the method described above, and by substituting the inspection likelihood into the equation of Expression 2 shown below, the error report density is determined. Then, by substituting the error report density and the wiring pattern area into the equation of Expression 3 below thereby to determine the verification work time. The verification time expressed by Expression 3 below is defined as a standard working time for production and represents the time checked by the operator per defect.

$$\begin{matrix}Error report density = \frac{n ( {\sum }_{i = 1}^{n} {x}_{i} {y}_{i} ) - ( {\sum }_{i = 1}^{n} {x}_{i} ) ( {\sum }_{i = 1}^{n} {y}_{i} )}{n ( {\sum }_{i = 1}^{n} {x}_{i}^{2} ) - ( {\sum }_{i = 1}^{n} {x}_{i} )} \times Inspection likelihood & [ Expression 2 ] \\ Verification work time = error report density X wiring pattern area X vertification time & ( Expression 3 )\end{matrix}$$

As described above, according to this embodiment, in the case where a high multilayer printed wiring board having various intensity components is inspected, the optimal calibration position for determining the inspection threshold value having few error reports is determined. Further, the inspection property is improved by predicting the verification work time and optimizing the lead time of the inspection process.

An embodiment of the invention achieved by the present inventor is described above specifically. Nevertheless, this invention is not limited to this embodiment, and can of course be modified variously without departing from the spirit and scope thereof.

This invention is widely applicable to an inspection system in which a defect of a wiring pattern formed on a printed wiring board having a plurality of layers such as a high multilayer printed wiring board can be inspected by image processing.

It should be further understood by those skilled in the art that although the foregoing description has been made on embodiments of the invention, the invention is not limited thereto and various changes and modifications may be made without departing from the spirit of the invention and the scope of the appended claims.

1. An inspection parameter setting method for an inspection system to inspect, by image processing, a defect of a wiring pattern formed on a printed wiring board having a plurality of layers, the inspection system performing the operation comprising the steps of:
synthesizing a CAD data from the CAD data and the layer structure information of each layer of the printed wiring board;
correcting the synthesized CAD data based on the etching factor and generating an intensity composition map viewed through the inspection surface;
determining a plurality of sets of intensity components of the inspection surface based on the intensity composition map; and
determining at least one intensity evaluation region covering all the sets.

2. The inspection parameter setting method according to claim 1,
wherein the inspection system images the intensity evaluation region, and determines each statistical intensity value by acquiring and analyzing the intensity data corresponding to each intensity component.

3. The inspection parameter setting method according to claim 2,
wherein the inspection system substitutes each of the statistical intensity values into the intensity composition map and determines the optimal calibration position to determine an inspection threshold value.

4. An inspection property evaluation method for an inspection system to inspect, by image processing, a defect of a wiring pattern formed on a printed wiring board having a plurality of layers, the inspection system performing the operation comprising the steps of:
synthesizing a CAD data based on the CAD data and the layer structure information of each layer of the printed wiring board;
correcting the synthesized CAD data based on the etching factor and generating an intensity composition map by viewing the CAD data through the inspection surface;
determining a plurality of sets of intensity components of the inspection surface based on the intensity composition map;
determining at least one intensity evaluation region covering all the sets;
imaging the intensity evaluation region;
determining each of the statistical intensity values by acquiring and analyzing the intensity data corresponding to each intensity component;
calculating the probability density distribution of each intensity component based on the intensity composition map and the statistical intensity value; and
determining the inspection likelihood based on the manner in which the intensity component adjacent to the intensity component on high intensity side interferes with the probability density distribution.

5. The inspection property evaluation method according to claim 4,
wherein the inspection system performs the operation comprising the steps of:
imaging the intensity evaluation region;
determining each statistical intensity value by acquiring and analyzing the intensity data corresponding to each intensity component;
substituting each of the statistical intensity values into the intensity composition map thereby to determine the optimal calibration position for determining an inspection threshold value;
inspecting the inspection surface at the optimal calibration position;
determining the error report density based on the number of error reports based on the verification of the result of inspecting the inspection surface and the area of the wiring pattern; and
registering the error report density with the inspection likelihood in a library.

6. The inspection property evaluation method according to claim 5,
wherein the inspection system performs the operation comprising the steps of
calculating an approximation formula indicating the relation between the inspection likelihood and the error report density based on the inspection likelihood and the error report density registered in the library;
substituting the inspection likelihood of the printed wiring board to be actually inspected, into the approximation formula, thereby to detect the error report density; and
determining the verification work time based on the resulting error report density and the area of the wiring pattern of the printed wiring board.

7. An inspection system for inspecting, by image processing, a defect of a wiring pattern formed on a printed wiring board having a plurality of layers, comprising:
an inspection unit for inspecting the printed wiring board;
a storage unit for reading and storing the CAD data of each layer of the printed wiring board and the layer structure information thereof, and storing an intensity composition map, an etching factor, each intensity component, an intensity data and a statistical intensity value corresponding to said each intensity component, and the inspection likelihood and the error report density corresponding to said each intensity component;
an arithmetic unit for calculating the intensity composition map, a set of the intensity components, the statistical intensity value, the inspection likelihood, the error report density, the intensity evaluation region and the optical calibration position based on the information stored in the storage unit; and
a display unit for displaying the result of the arithmetic operation of the arithmetic unit;
wherein the arithmetic unit performs the operation including the steps of synthesizing a CAD data based on the CAD data and the layer structure information of each layer of the printed wiring board, correcting the synthesized CAD data based on the etching factor and thus generating an intensity composition map by viewing the CAD data through the inspection surface, determining a plurality of sets of intensity components of the inspection surface based on the intensity composition map, and determining at least one intensity evaluation region covering all the sets.

8. The inspection system according to claim 7,
wherein the arithmetic unit images the intensity evaluation region, and by acquiring and analyzing the intensity data corresponding to each intensity component, determines each statistical intensity value.

9. The inspection system according to claim 8,
wherein the arithmetic unit substitutes each statistical intensity value into the intensity composition map and determines the optical calibration position to determine an inspection threshold value.
